(19) United States
(12) Patent Application Publication
(10) Pub. No.: US 2025/0223498 A1
(43) Pub. Date: Jul. 10, 2025

(54) SINGLE-STAGE METHOD AND APPARATUS FOR PRODUCING REFORMED PYROLYSIS OIL AND HYDROGEN-RICH PYROLYSIS GAS

(71) Applicant: Fraunhofer-Gesellschaft zur Förderung der angewandten Forschung e.V., Munich (DE)

(72) Inventors: Simon MEIDENBAUER, Sulzbach-Rosenberg (DE); Andreas APFELBACHER, Sulzbach-Rosenberg (DE); Robert DASCHNER, Sulzbach-Rosenberg (DE); Johannes NEIDEL, Sulzbach-Rosenberg (DE)

(73) Assignee: Fraunhofer-Gesellschaft zur Förderung der angewandten Forschung e.V., Munich (DE)

(21) Appl. No.: 19/056,687

(22) Filed: Feb. 18, 2025

Related U.S. Application Data
(63) Continuation of application No. PCT/EP2023/075201, filed on Sep. 13, 2023.

(30) Foreign Application Priority Data
Sep. 14, 2022 (DE) 10 2022 123 547.5

(51) Int. Cl. C10B 3/00; C10B 31/02; C10B 33/02; C10B 47/20; C10B 49/06; C10B 51/00; C10B 53/00; C10G 1/02

(52) U.S. Cl. CPC C10B 3/00; C10B 31/02; C10B 33/02; C10B 47/20; C10B 49/06; C10B 51/00; C10B 53/00; C10G 1/02; C10G 2300/1003; C10G 2300/1014; C10G 2300/1018

(57) ABSTRACT

In a method for producing pyrolysis oil, pyrolysis gas and pyrolysis coke, a starting material substantially comprising biomass is supplied to the upper region of a pyrolysis reactor. The latter has a substantially vertically arranged reactor chamber, which is substantially tubular. The reaction chamber then contains a bed of bulk material that comprises the starting material to be pyrolyzed and, optionally, the pyrolysis coke. This bulk material is thermally treated in the pyrolysis reactor, where the pyrolysis coke, the pyrolysis gases and the pyrolysis vapors are formed from the starting material to be pyrolyzed, and where the bulk material, the pyrolysis gases and the pyrolysis vapors are guided through the reaction chamber from top to bottom. The movement of the bulk material is caused substantially by gravity and the movement of the pyrolysis gases and pyrolysis vapors by the gas pressure building up.

### CROSS-REFERENCE TO RELATED APPLICATIONS

This application is a continuation of PCT/EP2023/075201filed Sep. 13, 2023, which claims priority under 35 USC § 119 to German patent application 102022123547.5 filed Sep. 14, 2022. The entire contents of each of the above-identified applications are hereby incorporated by reference.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 shows the schematic representation of an “annular gap” variant downpipe reactor;

FIG. 2 shows the schematic representation of a “riser” variant downpipe reactor;

FIG. 3 shows the schematic representation of a “flue gas ducts/lance” variant downpipe reactor; and

FIG. 4 shows the mass balances of the product spectrum produced.

### DETAILED DESCRIPTION

The application relates to a method and a reactor for thermally converting biomass to oil, gas and coke by means of simultaneously carrying out pyrolysis and reforming in the same reactor. The resulting oil, gas and coke are precursors for fuels, chemicals and also pure hydrogen.

During thermo-chemical conversion of biomass and biogenic residues, it is necessary to produce high-quality products such as thermally stable oil and hydrogen-rich gas in order to maximize economic efficiency. At the same time, simple and robust reactors should be used. A two-stage method, thermocatalytic reforming (TCR) (for example, described in M. Elmously et al. Ind. Eng. Chem. Res. 2019, 58, 35, 15853 ff), is currently used to produce the above-mentioned high-quality products. High product quality is ensured in this method, inter alia, using a medium-length biomass heating phase in the pyrolysis reactor, but also in the reforming of the pyrolysis vapors.

From an economic perspective, it is desirable to simplify the complexity of the reactors for the thermo-chemical conversion of biomass and—especially for small-scale use—to realize a less complex, preferably single-stage method with which good quality hydrogen-rich pyrolysis gas and pyrolysis oils can be obtained.

The present application describes a method in which pyrolysis and reforming are carried out simultaneously in a single reactor, i.e. are combined in a one-pot synthesis. This approach eliminates the need for the investment-intensive auger reactor during the pyrolysis of thermocatalytic reforming (TCR).

In its most general form, the method according to the application is characterized by:
providing a starting material substantially comprising biomass, in particular in the form of pieces;
supplying the starting material to a reactor having a substantially vertically arranged reactor chamber, where the reactor chamber is substantially tubular, in particular substantially cylindrical and/or substantially conical, where the starting material is supplied in the upper region of the pyrolysis reactor so that a bed of bulk material is present in the reaction chamber, where the bulk material comprises or consists of both the starting material to be pyrolyzed and the pyrolysis coke formed by the pyrolysis;
thermally treating the starting material in the pyrolysis reactor substantially in the absence of oxygen by means of at least one heating device for the reactor chamber, where thermal energy is introduced into the starting material using the heating device, and the pyrolysis coke, the pyrolysis gases and the pyrolysis vapors are formed from the starting material to be pyrolyzed, and where the bulk material, the pyrolysis gases and the pyrolysis vapors are guided through the reaction chamber from top to bottom, where the movement of the bulk material through the reaction chamber is caused substantially by gravity and the movement of the pyrolysis gases and the pyrolysis vapors through the reaction chamber is caused substantially by the gas pressure building up due to the thermal treatment of the starting material and where the thermal treatment takes place at least at a first temperature level of 300 to 650° C., in particular 300 to 500° C., for example 350 to 450° C. or also 300° C. to 400° C. and subsequently at a second temperature level of 450 to 900° C., preferably 500 to 800° C., for example 550° C. to 650° C. or 550° C. to 750° C., that is higher than the first temperature level; as a rule, the temperature difference between the first temperature level and the second temperature level is then at least 100° C., frequently at least 200° C., often at least 250° C. (where the temperature difference of at least 200° C. or at least 250° C. is typically realized in particular when the first temperature level is 450° C. or lower); the residence time of the bulk material (in the reaction chamber) is 1 to 1200 minutes, in particular 3 to 600 minutes, relatively long residence times typically being more advantageous; however, due to the better heat input in small-scale systems in particular, residence times of 1 to 60 minutes or 3 to 30 minutes can also be useful in order to be able to realize cost-effective systems; residence time should be understood to be the time during which the thermal treatment takes place, that is, the time during which the starting material or the bulk material is exposed to a temperature at least equal to the temperature of the first temperature level;
separating the pyrolysis gases and pyrolysis vapors obtained using the pyrolysis described above via an outlet arranged in the lower region of the pyrolysis reactor and separating the pyrolysis coke via a discharge device arranged in the lower region of the pyrolysis reactor and optionally providing pyrolysis oil by proportional condensation of the separated pyrolysis gas.

The reactor chamber is arranged substantially vertically. This means that deviations from exact vertical alignment of up to 40° are possible. It is preferred for the deviation from exact vertical alignment to be less than 20°, for example the deviation may also be less than 10°. According to the application, substantially cylindrical and/or substantially conical means that deviations from a circular or oval cross-sectional area are possible. In the substantially conical embodiment, the cross-sectional area of the reactor chamber decreases from bottom to top. Such an embodiment has the advantage that a possible blockage in the reactor can be counteracted. The substantially vertical orientation is important in particular because no apparatuses, or at least no significant apparatuses, are provided in the reaction chamber (i.e. in the space in which the thermal treatment of the bulk material takes place) for transporting the bulk material through the reaction chamber. The vertical orientation therefore ensures that gravity can act on the bulk material so that the latter can move through the reaction chamber (the term “downpipe reactor” is therefore also used below). It is understood that the more vertical the orientation of the reactor chamber, the better gravity can work. The same applies to the substantially cylindrical geometry; this ensures that the starting material is guided efficiently through the reactor and can be completely thermally treated in the reactor.

With the method according to the application, even very small-scale applications can be realized economically, which is an enormous advantage especially for biomass methods, since these are highly decentralized. Recycling centers (biowaste) or even larger agricultural companies can be considered as operators for these small-scale systems. The reactors used according to the application can therefore be realized in particular in small-scale systems having a size of 1 kg to 500 kg biomass throughput per hour. However, the systems can also be built larger, e.g. up to a throughput of 1500 to 3000 kg/h. In this case, the diameter of the reactor must generally be greater than that of the smaller reactors. Since the heat input into the biomass is the decisive factor in these types of systems, this heat input can be achieved in larger systems by means of heating lances or, depending on the orientation of the reactor, substantially vertical channels (in particular heating gas ducts) in the interior of the reactor. Thus, reactor diameters of a few centimeters to 1.5 meters or larger may easily be realized. Even larger diameters of up to 2.5 meters or even up to 5 meters can be realized, for example in designs in which the reactor enables good heat input into the bulk material and/or biomasses, in which a relatively rapid heat input can take place, in particular these diameters can be realized when using heating lances, heating gas ducts or the like in the reactor.

This can be done both for a cylindrically constructed reactor as well as for a conically designed reactor; even rectangular arrangements are possible; all of these geometries are included in the term “tubular” according to the application, since the most important aspect of the method according to the application is the movement of the bulk material formed from the starting material to be pyrolyzed and, if applicable, the pyrolysis coke through the reactor by means of gravity. What is important here is not the geometry of the reactor in the horizontal direction but substantially the unhindered movement of the bulk material in the interior of the reactor. This can be realized particularly well if no conveying devices are contained in the reactor, in particular no conveying devices such as screws and the like, and the vertical region of the reactor is substantially only characterized by a largely smooth surface.

As already explained, the method according to the application is carried out in a vertically arranged reactor driven by gravity. In this reactor arrangement, the resulting “pyrolysis vapors” must flow through the fixed bed from top to bottom due to the pressure built up by their formation and, after passing through at least two temperature levels, leave the reactor, in the lower region of the reactor, e.g. at the bottom. Strictly speaking, in the case of an integrated riser, pyrolysis gases and pyrolysis vapors usually leave the reactor at the top of the reactor; however, here too, the separation of gases/vapors and pyrolysis coke takes place in the lower region of the reactor. Since the reactor is pressure-tight and is closed by means of a lock on the input side and a similar lock system is or can be arranged on the solids side (coke discharge), the “pyrolysis vapors” formed in the reactor increase the pressure in the reactor. If the pressure generated in the reactor is higher than the pressure loss generated by the fixed bed, the “pyrolysis vapors” pass through the fixed bed and leave the reactor towards the condensation stage. Since the reactor is continuously supplied with input material, at least in continuous operation, the formation of “pyrolysis vapors” takes place continuously and thus “pyrolysis vapors” also leave the reactor continuously. Batch operation is also possible, but is less economical.

According to one embodiment, the residence time of the pyrolysis vapors in the reaction chamber is 0.1 seconds to one minute, in particular 0.5 to 30 seconds, for example 1 to 10 seconds. The residence time can be adjusted by determining the pressure built up in the reactor and a correspondingly controlled discharge of the pyrolysis vapors formed from the reaction chamber. Thus, it is possible to prevent excessive fragmentation of the product compounds formed by the reforming taking place in the reactor due to excessively long residence times of the pyrolysis vapors.

In the context of this application, “arranged in the lower region of the reactor” means that the starting material in the pyrolysis reactor must have substantially passed through the reactor zone. In particular, this shall be understood to mean that the pyrolysis vapors and pyrolysis gases must have completely passed through the first temperature level and substantially passed through the second temperature level. It is understood that the residence time specified in the application can only be achieved if the reactor geometry of the pyrolysis reactor is used in an appropriate manner. The discharge device will therefore often be arranged at the lower end of the reactor; the outlet for pyrolysis vapors and pyrolysis gases will therefore typically be arranged at the lower end of the heating device arranged at the bottom in the vertical direction (i.e. the heating device for realizing the highest realized temperature level), but at least not above the lower half in the vertical direction of this heating device arranged at the bottom. If more than two heating devices arranged vertically one above the other are used, in principle the outlet can be arranged further up, but in particular not above the lowest quarter of the heating regions formed by the heating devices in the vertical direction to create the temperature levels. Accordingly, if heating is provided only using heating gas ducts or the like and/or only using heating lances, the outlet is not arranged above the lowest quarter in the vertical direction of such heating devices. For the sake of completeness, it should be noted that for the above definition of a heating device, only those heating devices with which the temperature of the first temperature level and/or the second temperature level can be realized are to be taken into account.

At this point, it should be noted that it may be useful to thermally treat the bulk material in a vertical direction across a longer distance than the pyrolysis vapors. As already mentioned, a residence time that is too long can lead to excessive cracking of the pyrolysis vapors. However, with regard to the bulk material, a longer residence time can be used to ensure the bulk material is converted to higher-quality solids, for example because even more complete extraction of pyrolysis gases and pyrolysis vapors is then possible, producing purer pyrolysis coke, which in turn can be used as a long-term fertilizer in agriculture, etc.

As already stated, according to one embodiment, the temperature control or the selection of the heating devices can be such that a temperature gradient is formed in the bulk material. This temperature gradient can be adjusted in the vertical direction (according to the orientation of the reactor) (for example using heating devices in the form of gas ducts in the vertical direction or by appropriately controlled heating devices).

It is also possible to realize a plurality of different temperature levels by arranging a plurality of heating devices in a vertical direction, so that this at least comes close to a gradient. For example, reactors with 4, 5, 6 or more heating devices arranged one above the other in the vertical direction (above the outlet for pyrolysis vapors and pyrolysis gases) can be realized, where the, for example, jacket-like heating devices each have or provide temperature levels that increase from top to bottom and each next higher temperature level is at least 50° C. greater than that of the previous level. A vertical gradient can also be realized using the aforementioned plurality of heating devices if the individual, for example jacket-like, heating devices themselves can each achieve a temperature level that increases from top to bottom (in this case, as well, with reference to the example given above, the then averaged temperature level of such heating devices in each case is at least 50° C. above that of the previous level).

However, the temperature gradient can also additionally (or alternatively) be adjusted in the horizontal direction (that is, in the direction of the reactor cross-section). The latter can be realized, e.g., using downpipes having a large diameter that are heated exclusively by means of heating devices arranged on the outside of the reactor, or using heating devices arranged substantially vertically in the reactor according to the reactor geometry at correspondingly large intervals from one another. In this case, especially with shorter residence times of the bulk material in the reactor, a temperature gradient also forms in the horizontal direction. Usually, in the case of a temperature gradient in the horizontal direction when heating via only a few, for example jacket-like heating devices arranged vertically one above the other, the temperature levels of the heating devices (above the outlet for pyrolysis vapors and pyrolysis gases) are further apart. For example, with only two of these heating devices, they can have or provide these temperature levels at an interval of 200° C., for example 450° C. and 650° C. If there are three such heating devices, they can have, for example, intervals of 150° C., so that the first temperature level is 350° C. and the second temperature level is 650° C.; between these two temperature levels, a further temperature level of 500° C. is then realized.

With such a horizontally formed temperature gradient, it must be ensured that the temperature of the bulk material in the region in which pyrolysis gases and pyrolysis vapors are separated from the pyrolysis coke (that is, for example, the lower end of a riser used to separate gases and vapors) has reached at least the second temperature level. This can be determined, for example, by means of a temperature sensor that is arranged a few centimeters below the opening with which or via which the separation takes place.

According to the application, it was found that in methods that include temperature gradients, the quality of the pyrolysis products formed is often better than in methods that only include two or three temperature levels. Without wishing to be limited to this, the inventors explain this by the fact that the vapors are formed in a step-wise manner (typically, the chemical bonds that are particularly easy to break are first cracked; decarboxylation, decarbonylation and intermolecular dehydration then begin starting at temperatures of around 300° C.; the formation of more stable structures of the molecules formed takes place starting at temperatures of around 400° C.; aromatization, dimerization and diene reactions, inter alia, begin above 500 to 600° C.).

Accordingly, based on these theoretical considerations and explanations and taking into account the relatively short residence times of the pyrolysis vapors, a first temperature level in the range of about 300 to 500° C. and, what is much more relevant, a second temperature level above 500° C. (usually at least 100° C. higher), but especially in the range between 50° and 750° C., should be particularly suitable, even in arrangements without temperature gradients, to realize high-quality pyrolysis oils and a particularly efficient thermocatalytic reaction. Such high-quality pyrolysis oils are characterized in particular by a high proportion of aromatic hydrocarbons, such as alkylbenzenes, naphthalenes, styrenes or indoles. Aromatic hydrocarbons, especially alkylbenzenes, are desirable as antiknock agents in gasoline. Naphthalenes and indoles are also commercial fuel additives and have a positive effect on fuel quality.

As starting material or biomass contained in the starting material, the following are particularly suitable: cellulose-containing materials (in particular wood waste, agricultural waste and straw), industrial biomass waste (in particular digestates, brewer's spent grains, grape pomace, olive pomace, nut shells or coffee waste), waste fats and animal fats not approved for consumption and feed production, slurry from paper recycling, as well as materials containing liquid manure and sewage sludge. It is understood that mixtures of these materials with one another can also be used as starting materials, or mixtures of the materials mentioned with other biogenic substances. The starting material can, for example, have a water content of 5 to 30% by weight, in particular 10 to 20% by weight.

The most important advantage of the method according to the application is a total simplification and thus also a reduction in cost of the existing thermocatalytic reforming (TCR) process. Instead of a screw reactor, a post-reformer and a heating system distributed between both systems, an empty, externally heated (or internally heated) tube can be used. Pyrolysis and reforming take place in the same tube. The tube can be completely filled with the bulk material, thus allowing a higher throughput compared to the conventional method. In order to achieve higher throughputs or a larger fillable volume, the tube can easily be extended in the vertical direction. There are essentially no other reactor parts in the downpipe, so a blockage is unlikely. According to the application, the residence time of the solid in the tube can be controlled via a coke discharge screw. The discharge device (for example, coke discharge screw) thus also indirectly controls the transport of the bulk material through the reactor. However, it is only relevant for the removal, but not for the actual movement of the bulk material through the reactor in the vertical direction. The process can be monitored very easily using the temperature distribution in the coke and also by means of the hydrogen concentration in the gas. Scaling up is also very simple; several tubes integrated in a common heating jacket can be installed close to one another. Unless heating lances are used, tube diameters should not be larger than 500 mm—otherwise problems with heat input into the biomass may arise.

Initial tests on a laboratory system initially showed that the oils produced were of lower quality than corresponding oils obtained with prior art TCR methods. However, an improvement in the quality of the oils produced could be achieved by extending the tube reactor, as this would allow the biomass to be heated for a longer period; alternatively, it is also possible to optimize the temperature control in the reactor.

The present invention is a significant simplification of the thermocatalytic method according to the prior art. A clear property or distinction between classic pyrolysis oils and the reformed oils according to the application is the significantly higher product quality. In the case of the pyrolysis gases according to the application, a very high hydrogen content (>20% by weight) and in the case of the oil according to the application, a low polarity, a low acid number and a low amount of oxygen in the oil (CHNO).

At this point, the parameter combination with which pyrolysis oils with a particularly good product quality are achieved should be summarized again: thermal treatment at a first temperature level of 300 to 500° C., for example 350 to 450° C., and subsequently at a second temperature level of 550° C. to 750° C., which is at least 200° C., in particular at least 250° C. higher than the first temperature level, in particular combined with pressures of 1.5 to 30 bar, for example 2.5 to 30 bar and, in addition to these pressures or independent of these pressures, with residence times of the pyrolysis vapors of 0.5 to 30 seconds, for example 1 to 10 seconds.

Like the TCR method, the method according to the application can also be carried out without the addition of a catalyst. The catalytic effect during reforming is therefore substantially achieved using the pyrolyzed solids formed.

The apparatus according to the application for carrying out the method according to the application and initially the method itself are described in more detail below, without limiting generality, using an exemplary description and using different usable reactors and examples.

The application describes a method for producing high-quality products, namely pyrolysis oil, synthesis gas and pyrolysis coke, for example for use as biochar, based on intermediate pyrolysis and a coupled reforming step. The process has been condensed so that pyrolysis and reforming can now be carried out in one step. Biomass and biogenic residues and waste materials are used as input materials and typically are somewhat fragmented in size and have a maximum water content of up to 30%; these can be up to 10-15% contaminated with plastic or soil material. The fragmented size lies in particular in a range of granular particles with an edge length of 2 mm up to 40 mm. The starting material will often have an average particle size according to DIN 661 65 of 0.1 to 80 mm, in particular a particle size of 2 to 40 mm. A proportion of fine fraction as dust up to approx. 10% by weight is permissible (this proportion can be determined by means of sieve analysis, i.e. vibration sieve analysis (tower/batch sieving) or air jet sieve analysis). In addition, an excessive fine fraction in the reactor due to a (too) high pressure loss could be detected. The system is arranged vertically like a heated downpipe. The biomass can be fed oxygen-free with a screw conveyor or using pneumatic conveyance via the lock into a heated, vertical tube. The feed is guided from top to bottom through the tube by means of gravity. The residence time of the solid in the downpipe can be controlled by means of a discharge screw that is flanged in particular at the bottom of the tube and, if necessary, cooled. The pyrolysis of the starting material or biomass now takes place in the downpipe; coke and pyrolysis vapors are produced. These migrate further downward through the tube; the bulk material in the tube is heated, in particular by means of a temperature gradient, to a coke temperature or the highest temperature level achieved, which is between 45° and 900° C. Since there is hot pyrolysis coke in the lower part of the tube and the pyrolysis vapors are guided on the method side such that they pass through the hot coke bed, reforming takes place in the same tube simultaneously with pyrolysis. The process runs in the absence of oxygen; it can be based in particular on an intermediate pyrolysis, where during the pyrolysis step residence times of the input material of 5 to 30 minutes of the solid in the tube are to be realized; however, according to the application, the solid residence times are typically somewhat longer, since, in addition to pyrolysis, the reforming also takes place in the same reactor due to the single-stage method. The downpipe can be heated externally either electrically or by means of a hot gas heat exchanger.

Regarding process temperatures, the downpipe can be heated from room temperature up to 750° C. or higher from top to bottom with increasing temperature; the gradient can increase continuously. The pyrolysis gases are then drawn off, in particular at the lower portion of the downpipe, and supplied to a fine dust filtration and condensation process. An advantage of this arrangement over previous applications is the use of a tube as a reactor. In contrast to the screw reactors used in the TCR method, the tube reactors according to the application are very robust against higher pressures. If a lock system is installed upstream or downstream of the tube reactor on the input side and on the discharge side, the reactor can be operated in the pressure range of several bar, typically up to 30 bar, in particular up to 10 bar, for example also in a pressure range of greater than 1.5 bar up to 5 bar, for example also in a pressure range of greater than 2.5 bar. Better product qualities and yields can usually be realized with higher pressures. In principle, pressures of 200 bar and more can be realized if the reactor is designed to be pressure-resistant, although from an economic point of view a reactor design for up to 30 bar is more advantageous. In principle, the method according to the application could also be carried out at pressures below normal pressure, for example at a pressure of a few mbar; but here too this is not advantageous from an economic point of view.

Higher pressures are in particular necessary when very fine material is used that would generate a high pressure loss in the post-reformer according to the prior art TCR method. Thus, the present reactor can also convert very fine biomasses, which is more difficult in the case of the prior art by means of TCR methods.

In addition, a higher pressure is advantageous because it can usually significantly reduce the formation of long-chain hydrocarbons (especially tars).

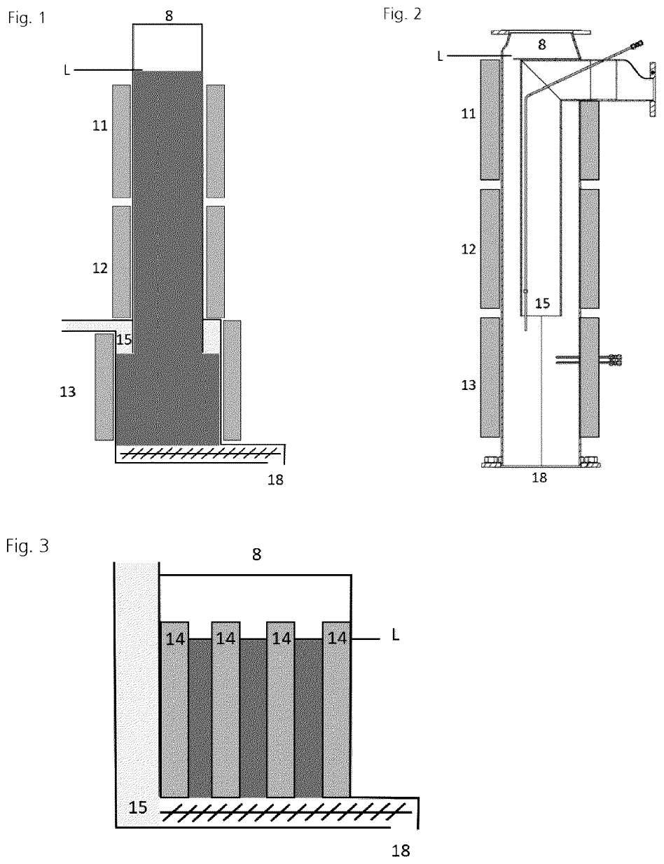

FIG. 1 shows the schematic representation of an “annular gap” variant downpipe reactor 1. The downpipe reactor 1 is filled with bulk material up to a level L. Three heating devices 11, 12 and 13 are arranged vertically above one another on the side and at least the upper two heating devices 11, 12 set the first and the second temperature level. The outlet 15 for pyrolysis gases and pyrolysis vapors is below the center heating device 12 (which sets the second (that is, the highest) temperature level in the bulk material). The outlet 15 is designed here as an annular gap; pyrolysis gases and pyrolysis vapors can be subsequently processed, for example using condensation, dust separation (in the cyclone) and/or aerosol separation (by means of an E-filter). The discharge device 18 for the pyrolysis coke is arranged at the lowest end of the reactor; a screw conveyor is used here to control the residence time of the solids. A supply device 8 for the starting material is arranged at the upper end of the reactor and is provided with a lock so that the reactor input can be sealed gas-tight on the side.

During operation, the reactor is therefore first filled with the starting material via the supply device 8 until the desired level L is reached. The uppermost heating device 11 sets the temperature level of at least 300° C., and the second temperature level of at least 450° C. is set by the heating device 12. Typically, however, the second (that is, the highest) temperature level (regardless of the selected reactor geometry) will have a temperature of at least 550° C. The reactor can then be operated in batch mode or continuously, with the appropriate starting material being added via the supply device 8. The starting material passes through the reaction chamber in the vertical direction substantially due to existing gravity; in addition, the feed can also be controlled via the speed of the discharge via the discharge device 18. However, gravity itself is essential simply because “braking” via the discharge device 18 must not lead to a blockage of the reactor (a blockage would be detected in particular if no new starting material is supplied, in particular because there is no longer any release via a level sensor L that may be present). The pyrolysis vapors and the pyrolysis gases are discharged from the reactor via the annular gap-shaped outlet 15. In order to ensure a sufficient residence time, a lock or a valve (not shown in FIG. 1) will typically be arranged downstream of the outlet 15.

FIG. 2 shows the schematic representation of a “riser” variant downpipe reactor in which, in contrast to FIG. 1, the gas outlet 15 does not take place via an annular gap but via a riser. It can be seen here that the lower end of the gas outlet 15 is arranged below the center heating device 12 and still projects into the region in which the lower-most heating device 13 is arranged. The possible position of a plurality of temperature sensors is not provided with reference symbols. The lower-most heating device 13 here merely improves the coal quality of the pyrolysis coke formed, a long coal residence time being crucial for this. Accordingly, it is no longer used to set a temperature that, as in FIG. 1, is greater than the temperature level realized by means of the heating device 12.

FIG. 3 shows the schematic representation of a “flue gas ducts/lance” variant downpipe reactor 1. Especially with this type of reactor, a large reactor diameter can be realized. Here, the heating devices are not (or not only) arranged on the outer surface of the reactor, but (also) in the interior thereof. The heating devices 11, 12, 13 are designed here as flue gas ducts 14, where the flue gas flows through the ducts from below to above, so that a temperature gradient can be realized in the reactor. The temperature is controlled such that the flow rate of the heating gas, in particular flue gas, is selected such that a temperature gradient is formed and the heating gas has at least the temperature of the second temperature level at the lower end of the flue gas ducts 14 and has the maximum temperature of the first temperature level at the upper end of the flue gas ducts 14 (where, regardless of the reactor geometries described in this section, the first temperature level is typically at least 50° C. lower than the second temperature level and is usually also at least 100° C. lower. In most cases, the difference in temperature levels is, as already mentioned above, more than 100° C. (in particular up to 300° C.). For example, a first temperature level is selected between 35° and 450° C. and a second temperature level is selected between 50° and 700° C. FIG. 3 also shows a design in which the outlet 15 for pyrolysis gases and pyrolysis vapors is arranged vertically at the very bottom of the reactor; specifically, the pyrolysis gases and pyrolysis vapors are only separated from the pyrolysis coke in the region of the discharge screw 18.

### Example: Pyrolysis and Reforming of Sewage Sludge

Experiments on the pyrolysis and reforming of sewage sludge were carried out in a reactor having a (vertical) length of 1.39 meters and a diameter of 0.27 meters and equipped with three heating mats of equal length and having a length of 40 cm arranged one above the other in the vertical direction as heating devices. The throughput of starting material can be adjusted by timing the screw conveyor. The temperature control is selected such that the first temperature level is reached at the lower end of the upper heating mat and the second temperature level is reached on average at the lower end of the center heating mat. The reactor is filled such that a volume up to a level L at just under 1.2 m is filled with bulk material, so that the upper end of the upper-most heating mat corresponds approximately to level L. Thus, when using sewage sludge granulate as starting material, a bulk density of approximately 500 to 550 kg/m³ is achieved. By using pressure operation in conjunction with a possible pressure loss of up to almost 100%, the requirements for the pretreatment of the input material can be reduced to a minimum, so that even difficult input materials can be used without being compacted. At least in the region of the lower-most heating mat, the bulk material during operation is substantially formed using pyrolysis coke. In the region of the two upper heating mats, the pyrolysis gases and pyrolysis vapors occurring during the combined pyrolysis/reforming process flow through the coke bed before being supplied to the outlet for pyrolysis gases and pyrolysis vapors. Particularly important for improving the quality of pyrolysis gases and pyrolysis vapors is the reactor section, typically arranged in the lower region of the second heating apparatus, in which the highest temperature level is realized. The pyrolysis vapors can flow through a cyclone downstream of the outlet for dust removal and are then cooled. Oil and water are then separated from the gas phase. To avoid oxygen in the system, the system can be continuously blanketed with a small amount of nitrogen, if necessary.

Two series of experiments are carried out, each with four sub-experiments. A reference experiment with the TCR method as described in WO2016/134794 A1 is carried out such that the vertical “downpipe” reactor as described above is additionally preceded by a pyrolysis reactor operated at 450° C. However, only exactly one temperature level is realized in the “downpipe” reactor, namely either 700° C. or, in a sub-experiment, 500° C. (hereinafter these experiments are referred to as 2.1 to 2.4). The experiment series according to the patent claims does not have an upstream pyrolysis reactor; temperature control via the heating mats is selected such that a temperature gradient between 250 to 300° C. and 500 to 700° C. is formed (these experiments are referred to below as 1.1 to 1.4). Each sub-test is carried out with a feed quantity of 150 kg of sewage sludge granulate which was obtained from the E&T Aichaberg sewage sludge dryer and had a bulk density of approx. 500 g/L. The sewage sludge granulate used contained 31% carbon, 4.3% hydrogen, 4.4% total nitrogen, 1.2% sulfur, 18% oxygen and an ash content (at 815° C.) of 41% in the dry matter; it was determined by means of mass spectrometry that it contained about 11-13% transition metals (in each case percentage by mass is given). The total water content was between 5 and 10 percent by mass. The sub-experiments can be found in Table 1 below:

TABLE 1

| | Solids | Temperature in the downpipe [° C.] or |
|---|---|---|
| Sub- | throughput | temperature gradient in the downpipe |
| experiment | [kg/h] | from to [C. °] |
| 1.1 | 5 | 300 to 700 |
| 1.2 | 10 | 300 to 700 |
| 1.3 | 20 | 250 to 650 |
| 1.4 | 10 | 250 to 480 |
| 2.1 | 5 | 700 |
| 2.2 | 10 | 700 |
| 2.3 | 20 | 700 |
| 2.4 | 10 | 500 |

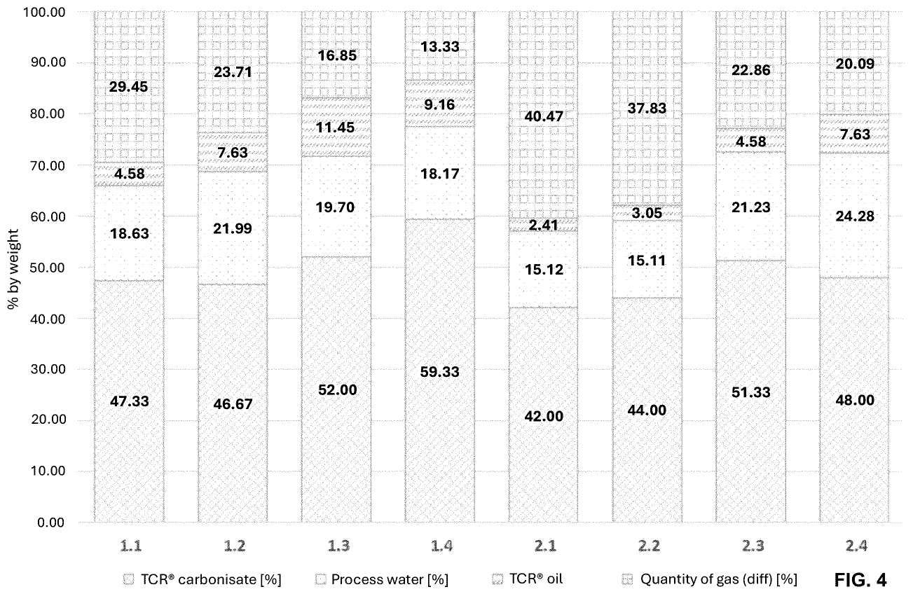

FIG. 4 shows the mass balances of the product spectrum produced. It can be seen that at (economically less relevant) slow throughput times with the method according to the application (1.1 to 1.4), significantly more gas and significantly less oil is formed than at faster throughput times (and lower temperatures). Compared to the TCR experiments (2.1 to 2.4), the oil content in the method according to the application is significantly higher.

Tab. 2 shows the parameters of the oil formed.

The measured values were determined as follows:

### Experiments 1.3, 1.4, 2.3 and 2.4:

Water content according to DIN EN 14346:2007-03
Fuel value and Calorific value according to DIN CEN/TS 16023, DIN SPEC 19524:2014-03
Ash content according to DIN EN ISO 6245:2003-01
Carbon content, nitrogen content and hydrogen content according to DIN 51732: 2014-07
Oxygen content according to ASTM D5622: 2017
Sulfur content according to DIN EN 14582:2016-12
Total Acid Number (TAN) according to DIN EN 12634:1999
Dynamic viscosity according to DIN EN ISO 3219:1994

### Experiments 1.1, 1.2, 2.1 and 2.2:

Water content according to DIN 51777
Fuel value according to DIN 51900
Carbon content, hydrogen content, nitrogen content and sulfur content according to DIN EN ISO 16948
Total Acid Number (TAN) according to ASTN D664

TABLE 2

| | | 1.1 | 1.2 | 1.3 | 1.4 | 2.1 | 2.2 | 2.3 | 2.4 |
|---|---|---|---|---|---|---|---|---|---|
| Water | % by | 1.6 | 1.6 | 4.80 | 3.40 | 1.9 | 2.2 | 3.10 | 1.40 |
| | weight | | | | | | | | |
| Fuel value (HHV) | MJ/kg | 36.30 | 37.30 | 33.50 | 34.80 | 36.4 | 37.2 | 31.60 | 34.10 |
| Calorific value | MJ/kg | Not | Not | 31.40 | 32.70 | Not | Not | 30.00 | 32.20 |
| (LHV) | | calculated | calculated | | | calculated | calculated | | |
| Ash content | % by | Not | Not | 0.20 | 0.40 | Not | Not | 0.20 | 0.20 |
| (775° C.) | weight | calculated | calculated | | | calculated | calculated | | |
| Carbon | % by | 78.7 | 77.5 | 73.40 | 73.70 | 77.9 | 77.4 | 75.40 | 78.10 |
| | weight | | | | | | | | |
| Oxygen | % by | Not | Not | 9.10 | 7.10 | Not | No | 5.30 | 4.80 |
| | weight | calculated | calculated | | | calculated | calculated | | |
| Hydrogen | % by | 8.1 | 9.8 | 9.40 | 9.50 | 9.1 | 7.4 | 7.00 | 9.00 |
| | weight | | | | | | | | |
| Nitrogen | % by | 7.2 | 7.3 | 6.17 | 5.47 | 7.4 | 9.1 | 8.67 | 6.58 |
| | weight | | | | | | | | |
| Sulfur | % by | 1.1 | 0.8 | 1.10 | 1.50 | 1.2 | 1.1 | 1.00 | 1.20 |
| | weight | | | | | | | | |
| TAN | mg | 0.7 | 1.6 | 18.74 | 16.29 | 6.9 | 2.4 | 1.46 | 1.38 |
| | KOH/g | | | | | | | | |
| Dyn. viscosity | mPa*s | Not | Not | 65.70 | 44.40 | Not | Not | 14.80 | 8.22 |
| (20° C.) | | calculated | calculated | | | calculated | calculated | | |

It can be seen that the qualities of the oils formed with the sub-experiments according to the application (1.x) are comparable to those obtained by means of the previously known TCR methods (sub-experiments 2.x).

Tab. 3 shows the gas composition of the gas formed

| | 1.1 | 1.2 | 1.3 | 1.4 | 2.1 | 2.2 | 2.3 | 2.4 |
|---|---|---|---|---|---|---|---|---|
| CH4 [% by volume] | 15.44 | 15.94 | 14.57 | 12.47 | 14.34 | 14.03 | 15.10 | 15.12 |
| CO [% by volume] | 14.40 | 13.45 | 12.37 | 7.99 | 15.24 | 12.72 | 13.16 | 7.99 |
| CO2 [% by volume] | 18.19 | 15.94 | 27.06 | 44.42 | 14.59 | 15.33 | 17.04 | 27.67 |
| H2 [% by volume] | 43.45 | 43.09 | 34.77 | 20.85 | 45.59 | 40.45 | 40.23 | 34.23 |
| H2S [% by volume] | 0.52 | 1.74 | 2.20 | 3.51 | 0.57 | 0.65 | 0.90 | 2.28 |
| Ethane [% by volume] | 1.96 | 2.49 | 2.45 | 3.12 | 2.58 | 2.72 | 3.45 | 4.28 |
| Ethylene [% by volume] | 2.36 | 2.24 | 1.84 | 1.21 | 4.13 | 3.91 | 3.99 | 1.85 |
| Propane [% by volume] | 0.56 | 1.25 | 1.47 | 2.53 | 0.35 | 4.02 | 1.08 | 2.57 |
| Propene [% by volume] | 2.75 | 3.11 | 2.33 | 2.14 | 2.45 | 5.87 | 4.42 | 2.71 |
| n-butane [% by volume] | 0.080 | 0.324 | 0.441 | 0.877 | 0.030 | 0.060 | 0.151 | 0.442 |
| n-pentane [% by volume] | 0.025 | 0.067 | 0.184 | 0.390 | 0.003 | 0.010 | 0.054 | 0.357 |
| n-hexane [% by volume] | 0.245 | 0.274 | 0.257 | 0.390 | 0.096 | 0.192 | 0.411 | 0.404 |
| n-heptane [% by volume] | 0.021 | 0.067 | 0.062 | 0.117 | 0.024 | 0.019 | 0.026 | 0.113 |

The contents were determined by means of gas chromatography.

It can be seen from the table that the hydrogen value decreases slightly as throughput increases (both for the experiments according to the invention and the TCR experiments). The temperature in the reactor has a significant influence on the hydrogen value. In particular, the CO concentration drops considerably at lower temperatures, whereas the CO2 concentration increases significantly. Regarding the formation of oils that are reformed under the present reaction conditions, it can be seen that with longer residence times (=lower throughput) or higher temperature, better reforming takes place and consequently more cracking takes place and the molecular length decreases.

In conclusion, it should be noted that the thermal treatment according to the application by means of the vertically oriented reactor, with a suitable adjustment of the residence time, in particular of the vapors and gases (but also of the solids), delivers product qualities and yields that can also be achieved according to the prior art (TCR method), but with a considerable simplification of the technical method. This is especially true if a sufficient temperature is introduced into the pyrolyzed starting material, which can be realized in particular given higher temperatures during the thermal treatment and sufficient residence time. However, for economic reasons, an extension of the residence time is less advantageous, so an alternative is to extend the (vertical) reactor or the thermal treatment zone in the reactor.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

1. A method for producing pyrolysis oil, pyrolysis gas and pyrolysis coke having the following steps:
A) Providing a starting material substantially comprising biomass, in particular in the form of pieces;
B) Supplying the starting material to a pyrolysis reactor having a substantially vertically arranged reactor chamber, wherein the reactor chamber is substantially tubular, in particular substantially cylindrical and/or substantially conical, wherein the starting material is supplied in the upper region of the pyrolysis reactor so that a bed of bulk material that comprises the starting material to be pyrolyzed and optionally the pyrolysis coke is present in the reaction chamber;
C) Thermally treating the starting material in the pyrolysis reactor substantially in the absence of oxygen by means of at least one heating device for the reactor chamber, wherein the pyrolysis coke, the pyrolysis gases and the pyrolysis vapors are formed from the starting material to be pyrolyzed and wherein the bulk material, the pyrolysis gases and the pyrolysis vapors are guided through the reaction chamber from top to bottom, wherein the movement of the bulk material through the reaction chamber is caused substantially by gravity and the movement of the pyrolysis gases and the pyrolysis vapors through the reaction chamber is caused substantially by gas pressure building up due to the thermal treatment of the starting material; and
wherein the thermal treatment takes place at least at a first temperature level of 300 to 650° C., and subsequently at a second temperature level of 450 to 900° C. that is higher than the first temperature level, wherein the residence time of the bulk material is 1 to 1200 minutes;
D) Separating the pyrolysis gases and pyrolysis vapors via an outlet arranged in the lower region of the pyrolysis reactor and separating the pyrolysis coke via a discharge device arranged in the lower region of the pyrolysis reactor and optionally providing pyrolysis oil by proportional condensation of the separated pyrolysis gas.

2. The method of claim 1, wherein a pressure-resistant reactor is used as the reactor for steps B) and C) and in particular the supplying in step B) takes place via a lock, in particular a lock closed on the input side, and optionally also the discharge of the pyrolysis coke in step D) takes place via a lock, in particular a lock closed on the discharge side.

3. The method of claim 1, wherein in step C) the residence time of the pyrolysis vapors in the reaction chamber is 0.1 seconds to one minute.

4. The method of claim 1, wherein the difference between the first temperature level and the second temperature level is at least 100° C.

5. The method of claim 1, wherein in step C) the at least one heating device is designed such that a plurality of temperature levels increasing from top to bottom can be formed, in particular such that a temperature gradient can be formed in the reaction chamber.

6. The method of claim 1, wherein the arrangement and design of the at least one heating device is selected such that a temperature gradient is formed in the reaction chamber in the horizontal direction.

7. The method of claim 6, wherein the highest temperature level or the highest temperature of the temperature gradient formed in the reaction chamber is at least 650° C.

8. The method of claim 1, wherein the starting material is selected from digestates, digestates from biogas and bioethanol methods, cellulose-containing materials, wood waste, agricultural waste and straw, industrial biomass waste, brewer's spent grains, grape pomace, olive pomace, nut shells or coffee waste, waste fats or animal fats, slurry from paper recycling, and materials containing liquid manure and sewage sludge or mixtures thereof.

9. The method of claim 1, wherein the starting material contains at least 85% by weight of biomass, wherein in addition to the biomass, up to 10-15% plastics or soil material are present in the starting material.

10. The method of claim 1, wherein the starting material provided has a water content of 5 to 30% by weight.

11. The method of claim 1, wherein the starting material provided is supplied in an average particle size according to DIN 661 65 of 0.1 to 80 mm.

12. The method of claim 1, wherein in step C) 1 kg to 3000 kg of starting material can be processed per hour.

13. The method of claim 1, wherein a discharge screw for the pyrolysis coke is provided for controlling the residence time of the bulk material in the reactor.

14. The method of claim 1, wherein the heating in step C) takes place via at least one heating device that surrounds the reaction chamber in a jacket-like manner and/or at least one heating lance in the interior of the reaction chamber.

15. The method of claim 1, wherein step C) is carried out in a reaction chamber, wherein the diameter of the reaction chamber is 2 cm to 150 cm.

16. The method of claim 15, wherein step C) is carried out in a reaction chamber having at least one heating lance in the interior of the reaction chamber, wherein the diameter of the reaction chamber is 50 cm to 150 cm.

17. The method of claim 1, wherein steps B) and C) are carried out in a plurality of similar pyrolysis reactors, wherein the thermal treatment according to step C) takes place at least in some of the pyrolysis reactors via a common heating device.

18. The method of claim 1, wherein the first temperature level is a temperature in a range of 300 to 500° C.

19. The method of claim 1, wherein the second temperature level is a temperature in a range of 500 to 750° C.

20. The method of claim 1, wherein the residence time of the bulk material is 3 to 600 minutes.
